(19) United States
(12) Patent Application Publication
(10) Pub. No.: US 2021/0256557 A1
(43) Pub. Date: Aug. 19, 2021

(54) A Method and System For Fulfilling an Action

(71) Applicant: IMAGENPAY UK LIMITED, Cheshire (GB)

(72) Inventors: Michael Donald, Cheshire (GB); Alexander Donald, Cheshire (GB)

(21) Appl. No.: 17/056,284

(22) PCT Filed: May 20, 2019
(86) PCT No.: PCT/EP2019/063008

§ 371 Date: Nov. 17, 2020

(30) Foreign Application Priority Data
May 18, 2018 (GB) 1808135.6
Aug. 22, 2018 (GB) 1813684.6

(51) Int. Cl. G06Q 30/02; G06Q 20/12

(52) U.S. Cl. CPC G06Q 30/0253; G06Q 20/12

(57) ABSTRACT

The computer implemented method comprises, in response to a user input in relation to a media item, using the media item to obtain information identifying the fulfilment entity (211). The method comprises interacting with the fulfilment entity using the obtained information identifying the fulfilment entity to fulfil the action (219). The media item is from a content distributor entity. The content distributor entity is different to the fulfilment entity.

The present invention relates to a method and system for fulfilling an action, and in particular fulfilling an action with a fulfilment entity via a fulfilment server.

It is common for brands to market their products through product endorsements on social media, or sponsorships. Typically, this involves the distribution of media via content distribution servers. Media may include images and videos. Images and videos are used as a communication method (e.g. emoji's) and are also a powerful way for brands to engage with customers.

A user may view the media, and as a result of viewing the media may decide to purchase a product associated with the brand from a merchant. Typically, the brand is not able to attribute that endorsement directly to a sale, e.g. because they advertise on a number of different platforms. Because of this, the brand is not able to accurately determine the effectiveness of the product endorsement or sponsorship.

Some content distributors do allow brands to add links next to online media, which may then direct a user to an e-commerce journey where the user will need to perform a number of steps to enable the transaction to take place. For example, the user may need to create an account, a password, and enter payment and user details to enable the payment process to take place. The payment and user details could include the email address, the postal address, the name, data of birth, and credit or debit card information. A problem of this approach is that a user is required to register separate accounts with multiple different merchants. This requires the user to repetitively register the same information with a number of different merchants, as well as remember a number of different user account and password information to access the accounts. Generally, the existing approaches are frustrating for the user and affect user engagement with merchants.

It is an object of the present invention to improve, or at least provide an alternative to, existing approaches for fulfilling an action with a fulfilment entity via a fulfilment server.

According to the present invention there is provided an apparatus and method as set forth in the appended claims. Other features of the invention will be apparent from the dependent claims, and the description which follows.

According to a first aspect of the present invention, there is provided a computer-implemented method of fulfilling an action with a fulfilment entity via a fulfilment server. The method comprises, in response to a user input in relation to a media item, using the media item to obtain information identifying the fulfilment entity. The method comprises interacting with the fulfilment entity using the obtained information identifying the fulfilment entity to fulfil the action. The media item is from a content distributor entity. The content distributor entity is different to the fulfilment entity.

Significantly, the media item is from a content distributor entity. From the media item itself, it may not be apparent who the fulfilment entity is for fulfilling an action. Even if the identify of the fulfilment entity is apparent, in existing approaches, the user may be required to manually navigate to a webpage of the fulfilment entity or click a hyperlink in order to be navigated to a webpage of the fulfilment entity to fulfil the action. In contrast to these existing approaches, the present invention uses the media item to obtain information identifying the fulfilment entity. This means that the fulfilment entity is identified from the media item without requiring any specific input from the user. The present invention is then able to interact with the fulfilment entity using the obtained information identifying the fulfilment entity so as to fulfil the action. This removes the requirement for a user to navigate to a fulfilment entity webpage so as to fulfil an action. Instead, the action is fulfilled through interaction with a media item provided from a content distributor entity.

In other words, the present invention links a media item (such as an image or video) directly to the performance of an action with a fulfilment entity. User navigation to a separate web page, etc., is not required.

Interacting with the fulfilment entity to fulfil the action may comprise controlling the fulfilment server to fulfil the action. That is, the media item may be used to identify the fulfilment entity and then trigger an operation to control the fulfilment entity via the fulfilment server. Controlling the fulfilment entity may mean triggering the fulfilment entity to fulfil the action.

The media item may be from a content distributor server provided by the content distributor entity. Server refers to a computer program or computer system. The server may be web server. The server may be provided by a single computer device or a number of computer devices cooperating together.

The method may comprise using the media item to obtain information identifying the action. This may mean that information identifying the action is obtained from the media item in addition to information identifying the fulfilment entity. Interacting with the fulfilment entity may comprise using the information identifying the action and the information identifying the fulfilment entity to fulfil the action.

Using the media item may comprise processing metadata associated with the media item to obtain the information identifying the action. The media item may thus contain or be associated with metadata. This metadata may be associated with the media item and may contain information which enables the action to be identified.

Using the media item may comprise processing metadata associated with the media item to obtain the information identifying the fulfilment entity. The media item may thus contain or be associated with metadata. This metadata may be associated with the media item, and may be extracted from the media item. The metadata may contain information which enables the fulfilment entity to be identified. The metadata may contain information which enables both the fulfilment entity and the action to be identified.

The metadata may comprise an identifier for the action. The metadata may comprise an identifier for the fulfilment entity. The identifier may be for both the action and the fulfilment entity. The identifier may also identify the cost of the action. The identifier may be a unique identifier for the action and/or the fulfilment entity. The identifier may be an alphanumeric identifier. The identifier may be in the form of an International Article Number, such as EAN-8 or EAN-13. Other forms of identifier are within the scope of the present invention.

In some examples, the metadata may comprise an identifier for the action. The method may comprise processing the identifier to identify the action, and then may comprise using the identified action to determine the fulfilment entity for fulfilling the action. The server or device processing the metadata may receive information associating a fulfilment entity with a particular action. The method may use this association to determine the fulfilment entity for fulfilling the action.

Using the media item may comprise using the identifier to look up the information identifying the action and/or the information identifying the fulfilment entity from a data store/repository. The data store/repository may comprise a look-up table that associates information identifying the action and/or information identifying the fulfilment entity with the identifier. In this way, the identifier may be used to obtain the information identifying the action and/or information identifying the fulfilment entity. Other ways of using an identifier to obtain information from a data repository are within the scope of the present invention.

The method may comprise receiving, by a user electronic device, the media item from the content distributor entity. The user electronic device may display the media item. The media item may comprise metadata. The user electronic device may recognise that the media item comprises metadata. The user electronic device may indicate to the user that the media item may be interacted with to fulfil an action, in other words the user electronic device may indicate to the user that the media item comprises metadata. The user electronic device may display a visual icon over the media item on the display so as to indicate that the media item comprises metadata. The icon may be interacted with by the user so as to trigger the media item being used to obtain information identifying the fulfilment entity. The user electronic device may only indicate to the user that the media item comprises metadata if the user electronic device has installed thereon a fulfilment application for use in the method according to the first aspect of the invention. Otherwise, the user electronic device may indicate to the user that the media item comprises metadata regardless of whether the user electronic device has installed thereon a fulfilment application. In such examples, the user interacting with the icon display over the media item may prompt the user to install the fulfilment application.

The media item is not required to comprise metadata in all examples. In some examples, the media item is processed directly to obtain the information identifying the fulfilment entity. The media item may also be processed directly to obtain the information identifying the action.

In one example, using the media item may comprise performing a visual search operation using the media item so as to identify the fulfilment entity. This may comprise performing a visual search operation using the media item so as to recognise an action associated with the media item, and using the recognised action to identify an associated fulfilment entity. For example, the action may be an action to purchase a product shown in the media item. The visual search operation may be performed to identify the product shown in the media item. The method may then identify a fulfilment entity that supplies the product. The method may then interact with the identified fulfilment entity to purchase the product.

The method may comprise receiving, by a user electronic device, the media item from the content distributor entity. The user electronic device may display the media item. A user interaction with the media item displayed on the display may trigger the visual search operation described above. The user electronic application may have installed thereon a fulfilment application. The fulfilment application may operate to indicate to the user that the media item may be interacted with so as to fulfil an action. The fulfilment application may operate to display a visual icon over the media item on the display so as to indicate that the media item may be interacted with by the user. The icon may be interacted with by the user so as to trigger the visual search operation used to obtain information identifying the fulfilment entity.

The method may comprise receiving the media item from a content distributor server. The method may comprise displaying the media item on a display of a user electronic device.

All or part of the method may be performed by a user electronic device. The user electronic device may receive the media item from a content distributor server. The user electronic device may display the media item on the display of the user electronic device. The user electronic device may receive a user input in relation to the media item. The user electronic device may, in response to receiving the user input in relation to a media item, use the media item to obtain information identifying the fulfilment entity. The user electronic device may interact with the fulfilment entity using the obtained information identifying the fulfilment entity to fulfil the action.

All or part of the method may be performed by a management server. The management server may be able to transmit and/or receive data from a user electronic device. The management server may receive an indication from the user electronic device that a user input has been provided in relation to the media item. In response, the management server may use the media item to obtain information identifying the fulfilment entity. The management server may obtain the media item from the user electronic device for use in obtaining the information identifying the fulfilment entity. The management server may obtain the media item from a different entity to the user electronic device. The management server may obtain metadata associated with the media item from the user electronic device for use in obtaining the information identifying the fulfilment entity.

The management server may comprise a user registration module. The user registration module may be arranged to store user details. The management server may comprise an encryption module. The encryption module may be arranged to encrypt information, e.g. prior to transmission to other servers/devices. The management server may comprise a decryption module. The decryption module may be arranged to decrypt information, e.g. received from other servers/devices.

All or part of the method may be performed by the user electronic device and the management server in cooperation. The method may be performed by a system. The system may comprise a management server. The system may comprise a user electronic device. The system may comprise a fulfilment server. The system may comprise a content distributor server. The system may comprise a payment server.

The method may comprise inserting metadata into a media item. The metadata may be for use in obtaining information identifying the fulfilment entity. The metadata may be inserted into the media item by the management server. The management server may provide the media item to the content distributor server. The content distributor server may provide the media item to the user electronic device.

Inserting metadata into the media item may comprise: receiving a media item in response to a user interaction with the media item; identifying the fulfilment entity associated with the media item; and inserting metadata comprising information for use in identifying the fulfilment entity into the media item. Identifying the fulfilment entity may comprise performing a visual search operation using the media item so as to identify the fulfilment entity. This may comprise performing a visual search operation using the media item so as to recognise an action associated with the media item, and using the recognised action to identify an associated fulfilment entity. For example, the action may be an action to purchase a product shown in the media item. The visual search operation may be performed to identify the product shown in the media item. The method may then identify a fulfilment entity that supplies the product. The method may then insert metadata into the media item for use in identifying the fulfilment entity.

The method may comprise transmitting the media item comprising the metadata to a content distributor server.

In some examples, the action may not be fulfilled directly after the user interacts with the media item. The action may be added to a list of actions to be fulfilled (e.g. an action wish list) if the user is not ready to fulfil the action at that time. The user may return to the wish list to complete fulfilment of the action at a later date. At that time, the method may check that the action is still able to be fulfilled, and if so complete the fulfilment process. Additional information from the user may not be required.

The method of the present invention enables fulfilment entities and other associated entities to track the behaviours of users without capturing any personally identifiable information. In particular, the present invention enables the determination of which content distributor entity provided the media item that triggered the fulfilment of the action. In this way, the method enables the determination of which content distributor entities (e.g. social network services) are effective in triggering the fulfilment of an action.

The action may comprise undertaking a financial transaction to purchase a product or service associated with the media item. The fulfilment entity may be a merchant entity. The method may comprise, in response to receiving a user input in relation to a media item, using the media item to obtain information identifying the merchant entity, and optionally the information identifying the product or service to be purchased. Interacting with the fulfilment entity may comprise performing a payment process for purchasing the product or service from the merchant entity via the merchant server using the obtained information identifying the fulfilment entity.

Interacting with the fulfilment entity may comprise communicating with the fulfilment entity to obtain information about the product or service. This information may include details about the fulfilment entity, details about the price of the product or service, and details about available options for the product or service. This obtained information may be provided to the user, e.g. by displaying the information on the display of the user electronic device, before the payment process is executed. User authorisation of the payment process may be required before the payment process is executed. The user may not be required to input any additional information other than the authorisation to complete the payment process. This may be because user payment information, and optional information, may be pre-stored and obtainable for performing the payment process. The present invention is thus able to provide a frictionless and seamless buying experience using a user electronic device such as a mobile phone.

Performing the payment process may comprise using (e.g. pre-stored) user payment details. The user payment details may be pre-stored on a user electronic device or a management server. Performing the payment process may comprise communicating with a payment server. Performing the payment process may comprise using (e.g. pre-stored) user payment details and user preference information.

The method may allow for a content distributor to add metadata to media. This may be in cooperation with a management server. The metadata may mean that when the media item is displayed on a user electronic device (e.g. a mobile device), the user electronic device may display a visual indication (e.g. an icon) over the media item. This allows the user to trigger the fulfilment of an action (e.g. a purchase of a product shown in the media item), and as such the media item itself allows for the action to be fulfilled. The user providing a user input in relation to the icon may cause the metadata to activate a fulfilment application running on the user electronic device. The fulfilment application may display the fulfilment entity (e.g. merchant), price of the action (e.g. purchase price of the product) and options for the action. The fulfilment application may use the user's preferred payment method and interface directly with a payment server so that the user is not required to input any detail, other than confirmation that they wish to fulfil the action identified by the media (e.g. purchase the product shown in the media item).

The media item may be provided by a user. In this way, the user is the content distributor entity. For example, the user may capture an image or video using a camera of or associated with the user electronic device. The method may use the captured media item to obtain information identifying the fulfilment entity. The method may then interact with the fulfilment entity using the obtain information identifying the fulfilment entity to fulfil the action.

According to a second aspect of the invention, there is provided a computerised system for fulfilling an action with a fulfilment entity via a fulfilment server, the system being arranged to perform the method as described above in relation to the first aspect of the invention.

The system may comprise a management server.

The system may comprise a user electronic device.

The system may comprise a fulfilment server.

The system may comprise a content distributor server. The management server may be the same as the content distributor server or may be linked together. The content distributor server may use a widget provided by the management server for adding metadata to media.

According to a third aspect of the invention, there is provided a computer readable medium having instructions recorded thereon which, when executed by a computer, cause the computer to perform the method as described above in relation to the first aspect of the invention.

According to another aspect of the present invention, there is provided a system for managing transaction metadata, and applying the metadata to media using a back office tool. The system may comprise an electronic device, such as a mobile telecommunications device, which is associated with an end user, or an online tool. The end user may be a consumer or a content distributor. The system may comprise a management server configured to receive user preferences from the electronic device. The system may also be configured to receive an authorisation response from an external application, in response to receiving the authorisation response and based on user preferences, to transmit a command or notification to the electronic device to facilitate payment, and the e-commerce transaction.

The electronic device may be arranged to execute the downloaded fulfilment application to control the electronic device to carry out at least one function, method and/or operation as per the embodiments described herein. Moreover, the electronic device may be arranged to execute the downloaded consumer application to control the electronic device to perform a set of actions, the set of actions may comprise at least one of: make a transaction using a Digital Payment Wallet; process a card holder not present for payment; and interface into a chosen merchant that was set by the content distributor using the back-office tool.

The application may be sourced from an application store and/or content provider. For example, the content provider may comprise the Apple® App Store®. The content provider may comprise a cloud computing provider.

The input means of the electronic device may comprise a user-input apparatus arranged to receive an input from a user. In some embodiments, the user input apparatus may comprise a touch sensitive display screen. Advantageously, this allows a user to input data to the electronic device.

Preferably, the consumer application comprises a graphical user interface (GUI). The graphical user interface may comprise user-interactable artefacts such as buttons.

Preferably, the user-interactable artefacts may be displayed on the screen and receive a user input for selection or control of those artefacts. The electronic device may be controlled to selectively hide those artefacts in dependence on the state of the electronic device.

Preferably, the electronic device is controlled by the consumer application to provide preferences for payment transactions and e-commerce fulfillment, e.g. address and phone number.

The system may further comprise a management server. The management server may comprise at least one of: a user registration module; an encryption module; a decryption module; a payment card provider.

The system may further comprise a management database comprising at least one of: Payment Card truncated PAN and Token data.

The system may further comprise a management tool which comprises at least one of: buyable product detail, e.g. sizes and colours; merchant the product can be bought from; and acceptable payment methods. The management tool may attach metadata behind media that enables communication with the consumer application where payment preferences have been set.

According to another aspect of the invention, there is provided a method for managing transaction metadata applied to transactions carried out using a digital wallet or other payment method so that the consumer application can store activity for the consumer. The method may comprise performing a transaction using the digital wallet, receiving, at an electronic device acting as the digital wallet or at a management server in communication with the electronic device, a notification that a transaction has been successful, and product purchase will be fulfilled, and communicating a record to a user based on user preferences.

For a better understanding of the invention, and to show how embodiments of the same may be carried into effect, reference will now be made, by way of example only, to the accompanying diagrammatic drawings in which:

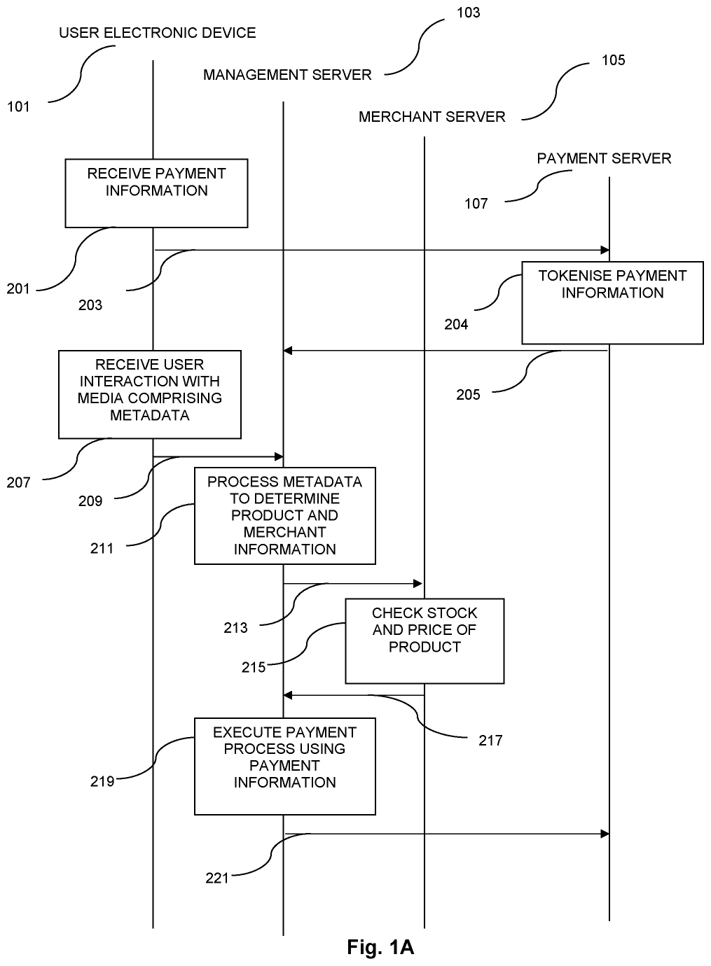

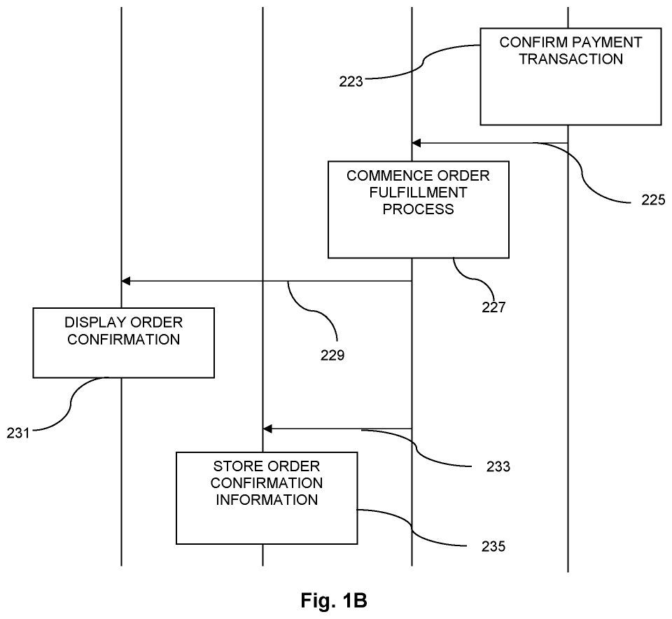

FIGS. 1A and 1 B show a signal flow diagram for an example process according to aspects of the present invention;

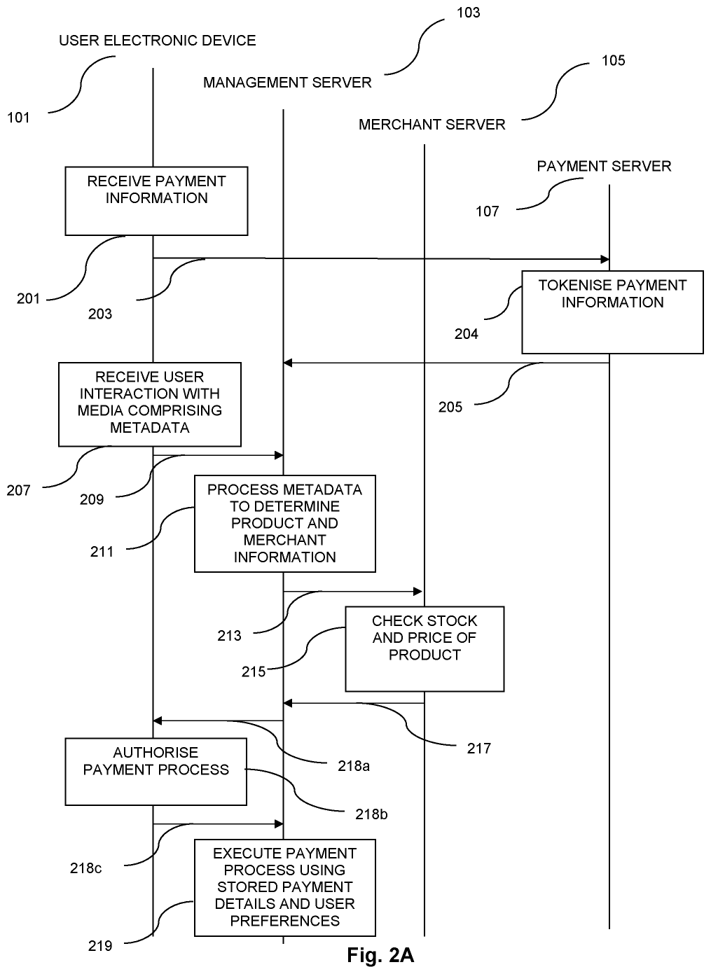

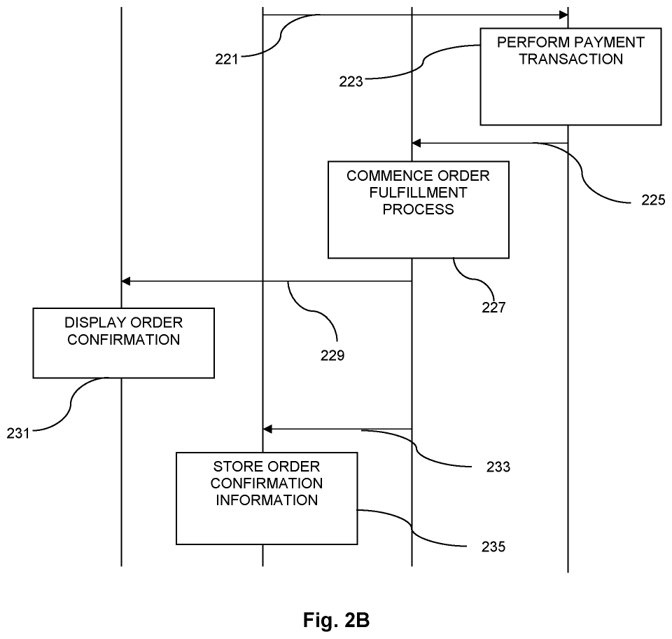

FIGS. 2A and 2B show a signal flow diagram for another example process according to aspects of the present invention;

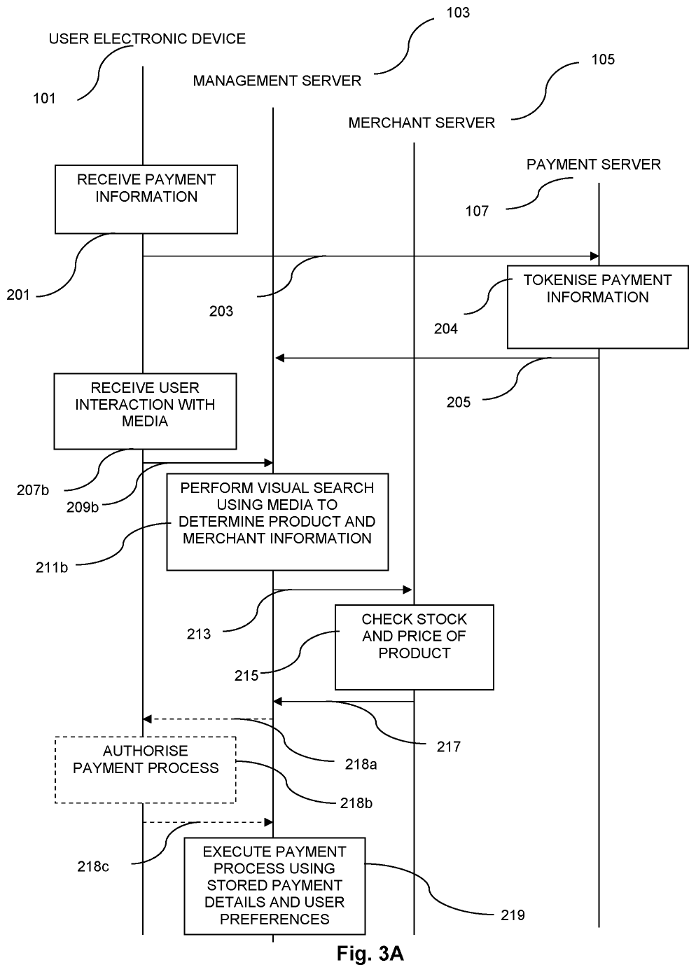

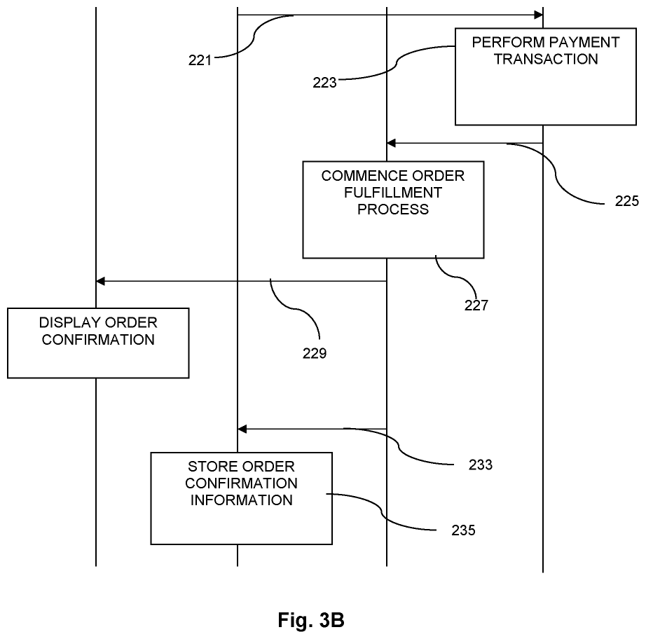

FIGS. 3A and 3B show a signal flow diagram for another example process according to aspects of the present invention;

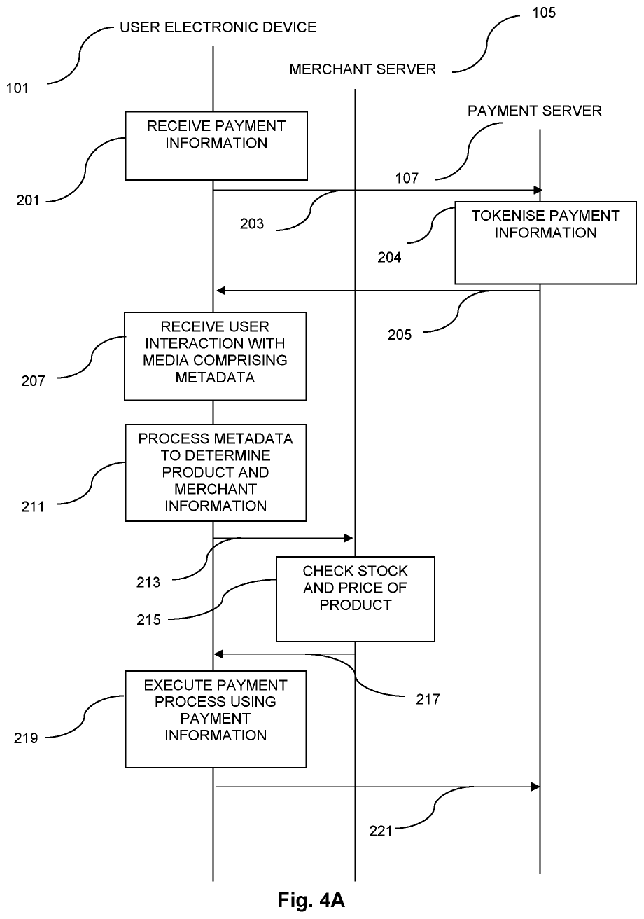

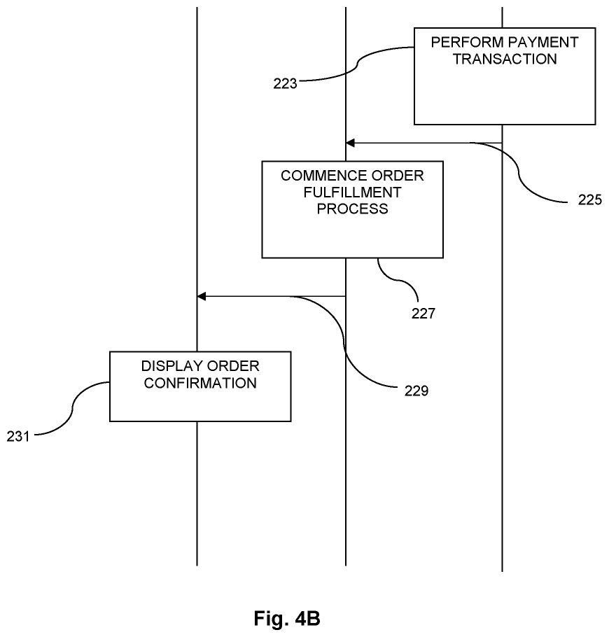

FIGS. 4A and 4B show a signal flow diagram for another example process according to aspects of the present invention;

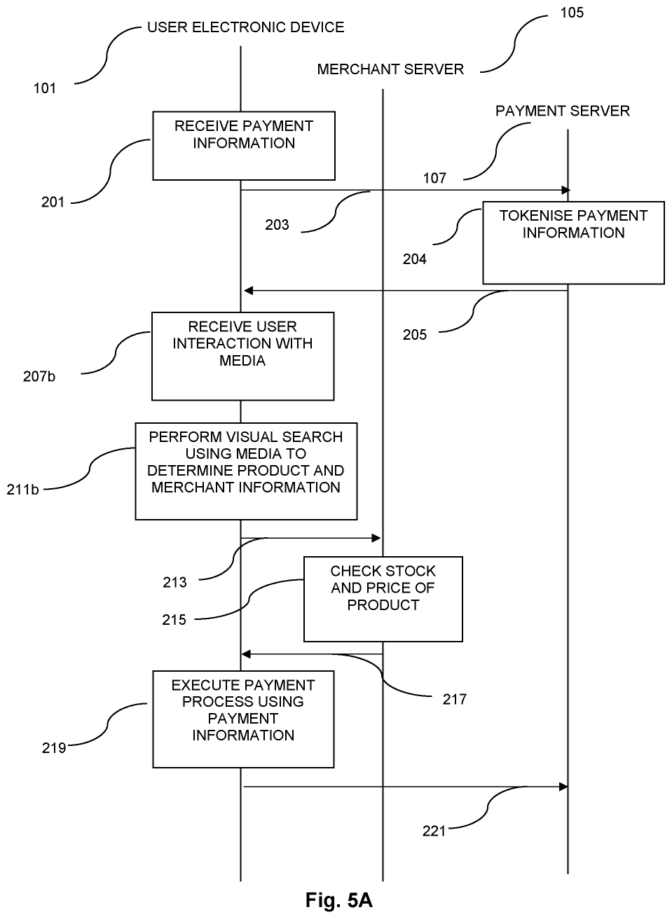

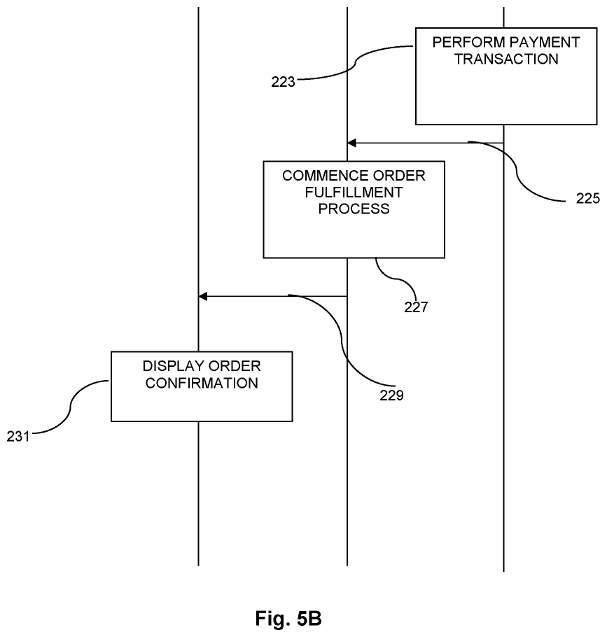

FIGS. 5A and 5B show a signal flow diagram for another example process according to aspects of the present invention;

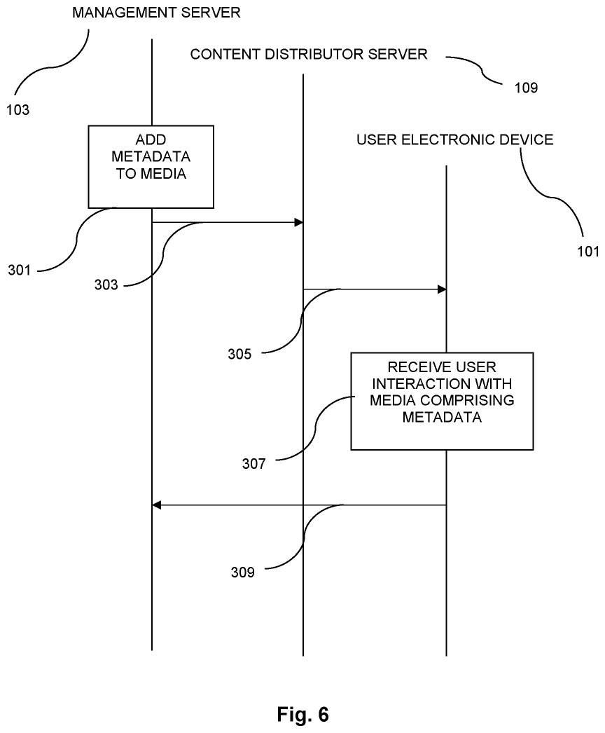

FIG. 6 shows a signal flow diagram for an example process for distributing media comprising metadata from a content distributor server to a user electronic device according to aspects of the present invention; and

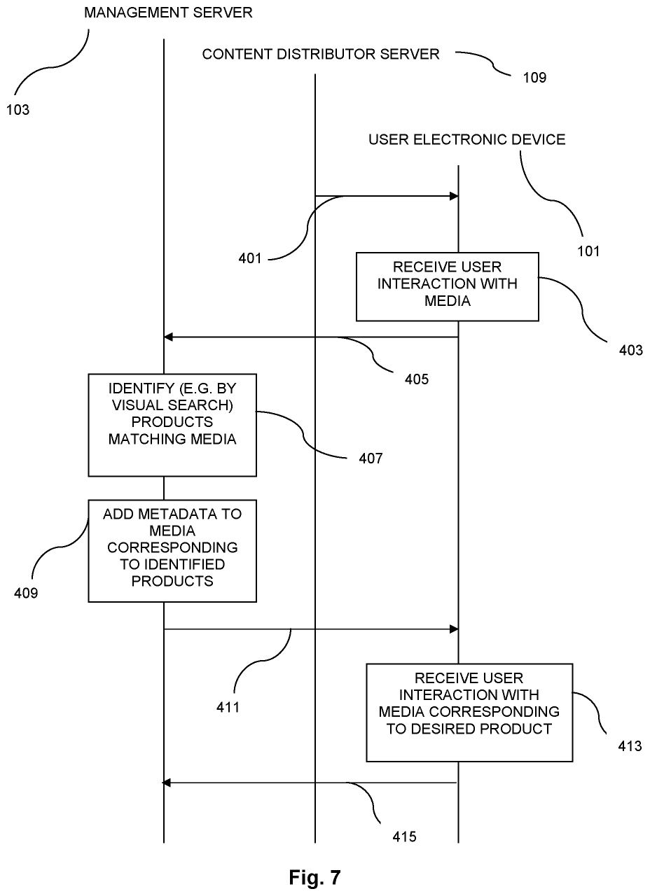

FIG. 7 shows a signal flow diagram for another example process for distributing media comprising metadata from a content distributor server to a user electronic device according to aspects of the present invention.

The below examples of the present invention refer to particular implementations of the invention. In these examples, the action to be fulfilled is to purchase a product associated with a media item. The fulfilment entity in these examples in thus a merchant entity, and the fulfilment server is a merchant server. It will be appreciated that not all examples of the present invention relate to purchasing a product or entity from a merchant entity. Instead, the present invention relates generally to fulfilling actions via a fulfilment server through interaction with a media item that is provided by a content distributor entity different to the fulfilment entity as described previously. The action to be fulfilled could be any appropriate action such as an action to share data with the fulfilment entity or control a device of the fulfilment entity.

Referring to FIGS. 1A and 1 B, there is shown a signal flow diagram for an example process according to aspects of the present invention. This example involves data interaction between four different devices/servers provided by four entities. A user electronic device 101 is operated by a user entity. A management server 103 is operated by a management entity. A merchant server 105 is operated by a merchant entity. A payment server 107 is operated by a payment entity. Other examples of the present invention may include more or fewer devices/servers/entities.

The user electronic device 101 may be a mobile electronic device 101 such as a laptop, tablet personal computer (PC), mobile phone or smart phone. The user electronic device 101 may be a projector, e.g. arranged to project a user interface onto a surface. The user electronic device 101 may be a desktop PC.

In this example, a user of the user electronic device 101 initially downloads a fulfilment application to their user electronic device 101, and installs the fulfilment application. The fulfilment application is able to interact with and control the device to perform the required function of the device. The fulfilment application may represent an application, service, or component executed at or accessible to the user electronic device 101. The fulfilment application may be a stand-alone application, service, or may be a module executed by other applications. The fulfilment application may be a stand-alone application or subroutine that is invoked by an application or operating platform of the user electronic device 101. In some examples, the user electronic device 101 may download and install the fulfilment application from an application repository of a service provider (e.g., an online application store accessible via the Internet). In other examples, the fulfilment application may be preloaded during production of the user electronic device 101.

After installation of the fulfilment application, a user is prompted by the user electronic device 101 to perform a registration process using an interface provided by the fulfilment application. The registration process may involve the user entering personal information, which may be used by the fulfilment application for the purpose of identifying the user and for subsequently authorising commands provided by the user.

The fulfilment application may control an encryption module of the user electronic device 101 to encrypt the personal information provided by the user via the fulfilment application interface and transmits the information to the management server 103, via an application programming interface (API). The management server 103 may control a decryption module of the management server 103 to decrypt the personal information and uses the personal information to create a profile for the user and stores the user profile in a user profile database as provided by a user registration module of the management server 103. The user profile database may comprise user profiles for a plurality of different users of a plurality of different user electronic devices. The multiple different user electronic devices may be able to communicate with the management server 103 at the same time, e.g. such that the management server 103 can facilitate purchase operations from multiple different users at the same time.

Once the user has registered with the management server 103, the user is able to input payment information via the fulfilment application interface. This enables the user electronic device 101 to receive the payment information as shown in step 201 of FIG. 1A.

In one example, the user may enter their payment information by manually entering the payment information (e.g. payment card information such as credit or debit card information) via the fulfilment application interface. The user may also use a camera of or associated with the user electronic device 101 to image a payment card, such that the payment information may automatically be obtained by the user electronic device 101 through appropriate processing of the captured image. The processing may be performed by the fulfilment application or an additional application running on the user electronic device 101. The entered payment information may also be stored on a digital wallet application running on the user electronic device 101. The user may also enter their payment information via the digital wallet application running on the user electronic device 101. The digital wallet application may be integrated with the fulfilment application such that the payment information may be transferred from the digital wallet application to the fulfilment application in a seamless way. The payment information may comprise the Primary Account Number (PAN) of the payment card, and may comprise the expiry date and/or security code of the payment card. Other forms of payment information are within the scope of the present invention.

Once the payment information is entered, the user may be required to enter an agreement/authentication process with the user electronic device 101. Once this process is complete, the payment information may be encrypted and transmitted from the user electronic device 101 to a tokenization platform.

In the example shown in FIG. 1A, the encrypted payment information is transmitted from the user electronic device 101 to the payment server 107 as shown in step 203 of FIG. 1A. In this example, the payment server 107 comprises the tokenization platform, but in other examples the tokenization platform may be remote to the payment server 107. The payment server 107 decrypts the payment information and uses the payment information to generate a token in the form of a card identifier, CID, as shown in step 204 of FIG. 1A. The payment information is stored on a data store of the payment server 107. The CID is a non-sensitive data equivalent to the payment information, and may be used as a reference to the payment card without requiring that sensitive information relating to the payment card is transferred via non-encrypted communications. The payment server 107 encrypts the CID and transmits the CID back to the management server 103 as shown in step 205 of FIG. 1A. The management server 103 may store the CID in the user profile database or a separate user accounts database. In another example, the user electronic device 101 may transmit the encrypted payment information to the management server 103 rather than the payment server 107. The management server 103 may then transmit the payment information to the payment server 107 for tokenisation.

The management server 103 may transmit the CID to the user electronic device 101. The management server 103 may transmit a confirmation message, e.g. without transmitting the CID, to the user electronic device 101 to confirm that the payment details have been successfully registered. The confirmation may be communicated to the user electronic device 101 via the fulfilment application. At this point, the fulfilment application may communicate additional data such as user-specific data or assets to the management server 103. Alternatively, such additional data may be transmitted at any other time.

After the enrolment process of the payment card is complete, the fulfilment application may prompt the user to enroll additional payment cards. In this case, the above described process may repeat until the user has finished enrolling payment cards.

Once the user is enrolled, the fulfilment application may prompt the user to select their preferred payment method and other user preference information. This preference information may be transmitted from the user electronic device 101 to the management server 103. The user preference information may mean that when a purchase process is commenced, a user's preferred payment method is selected, and the appropriate payment server 107 is interfaced with to perform the purchase. The user preference information may identify which particular payment card to use based on the item being purchased, the location (e.g. whether the user is in a foreign country), and/or the time or date.

Once the user is enrolled, the user may browse content from a content distributor server provided by a content distributor entity. The content may be social media content received from a social media server. The content provided by the content distributor server comprises media items. The media items may include image data or video data. Some or all of the media items may be associated with different products or services to be purchased.

In the example shown in FIG. 1A, media items provided by the content distributor comprise metadata. The fulfilment application running on the user electronic device 101 may identify media items comprising the metadata and may display on a screen of the user electronic device 101 an indication of the media items comprising metadata. In one particular example of this, the fulfilment application may display an icon over the media item comprising the metadata when the media item is displayed on the screen. The user may then interact with the media item comprising the metadata, e.g. by providing a user input in relation to the media item as shown in step 207 of FIG. 1A. The user input may be a user input to select or click on the icon displayed over the media item comprising the metadata.

In response to receiving the user interaction with the media item comprising the metadata, the fulfilment application may extract the metadata from the media item. The fulfilment application may then transmit the metadata from the fulfilment application to the management server 103 as shown in step 209 of FIG. 1A. The management server 103 may then process the metadata to determine product information identifying the product associated with the media item and merchant information identifying the merchant entity where the product may be purchased from, as shown in step 211 of FIG. 1A.

In this example, the metadata may be an identifier, e.g. in the form of an EAN-13 barcode number. The management server 103 uses the identifier to look up the information identifying the action and/or the information identifying the fulfilment entity from a data repository. The data repository may comprise a look-up table that associates information identifying the action and/or information identifying the fulfilment entity with the identifier. In this way, the identifier may be used to obtain the information identifying the action and/or information identifying the fulfilment entity. Other ways of using an identifier to obtain information from a data repository are within the scope of the present invention.

In step 213 of FIG. 1A, the management server 103 uses the obtained product information and merchant information to transmit a purchase request to the merchant server 105.

In step 215 of FIG. 1A, the merchant server 105 checks the availability and optionally the price of the product in response to receiving the purchase request from the management server 103. The merchant server 105 may also place a reserve on the product until the purchase process is completed.

In step 217 of FIG. 1A, the merchant server 105 transmits the stock information and, optionally, the price information to the management server 103. If the product is available for purchase, the management server 103 then executes a payment process using the payment information (step 219 of FIG. 1). In particular, the management server 103 transmits the encrypted CID associated with the user's preferred payment card to the relevant payment server 107 as shown in step 221 of FIG. 1A.

In step 223 of FIG. 1 B, the payment server 107 confirms the payment transaction. In step 225 of FIG. 1 B, the payment server 107 transmits a confirmation of the payment to the merchant sever 105.

In step 227 of FIG. 1 B, the merchant server 105 commences a fulfilment process to fulfil the purchase of the product.

In step 229 of FIG. 1 B, the merchant server 105 transmits a confirmation of the order of the product to the user electronic device 101. The confirmation may be transmitted via the management server 103. The user electronic device 101 may display a confirmation of the order as shown in step 231 of FIG. 1 B.

In step 233 of FIG. 1 B, the merchant server 105 transmits a conformation of the order of the product to the management server 103. The management server 103 may store confirmation of the order as shown in step 235 of FIG. 1 B. This may enable the management server 103 to have a central digital record of the transactions of different users. This transaction information may be stored in the user registration module of the management server 103. In this way, every time a product is purchased directly from a media item, the product purchase, and the unique identifier of the device will be recorded, which will start to build a detailed picture of the customer. This data will be used to show the customer a record of everything they have either shown an interest in, or bought. This data will then be used to help target the customer with products that are relevant for them. Importantly, no personally identifiable information is required to be stored in this monitoring process.

Referring to FIGS. 2A and 2B, there is shown a signal flow diagram for an example process according to aspects of the present invention. The process is similar to the example shown in FIGS. 1A and 1 B and uses like reference numerals to indicate like components/process steps.

The process shown in FIGS. 2A and 2B differs from that in FIGS. 1A and 1 B in that an additional authentication stage is provided as indicated by the reference numerals 218a-218c in FIG. 2A. In particular, after the management server 103 receives the stock and price information of the product for purchase, the management server 103 requests that the user electronic device 101 confirm that the payment process should take place. The management server 103 may provide information about the merchant, the product, and the price of the produce to the user electronic device 101 as shown in step 218a of FIG. 2A. The user electronic device 101 may display or otherwise provide this information to the user, and request that the user authorises the payment process as shown in step 218b of FIG. 2A. The user electronic device 101 transmits indication of the user's authentication to the management server 103 as shown in step 218c of FIG. 2A. Provided the user has approved the payment process, the management server 103 executes the payment process as shown in step 219 of FIG. 2A.

Referring to FIGS. 3A and 3B, there is shown a signal flow diagram for an example process according to aspects of the present invention. The process is similar to the example shown in FIGS. 1 and 2 and uses like reference numerals to indicate like components/process steps.

The process shown in FIGS. 3A and 3B differs from that in FIGS. 1 and 2 in that the media item does not comprise metadata. Instead, in this example, the user interacts with the media in step 207b and the user electronic device 101 transmits the media to the management server 103 in step 209b of FIG. 3A. The management server 103 then performs a visual search operation using the received media to determine the product and merchant information as shown in step 211b of FIG. 3A.

The example of FIGS. 3A and 3B also includes the user authorisation process described above in relation to FIGS. 2A and 2B and indicated by the reference numerals 218a, 218b, and 218c. This authorisation process is optional as indicated by the use of dashed lines in FIGS. 3A and 3B.

Referring to FIGS. 4A and 4B, there is shown a signal flow diagram for an example process according to aspects of the present invention. The process is similar to the example shown in FIGS. 1, 2 and 3 and uses like reference numerals to indicate like components/process steps. The process shown in FIGS. 4A and 4B differs from that in FIGS. 1, 2 and 3 in that the user electronic device 101 performs the steps of processing the metadata 211 and executing the payment process 219 rather than the management server 103. The management server 103 is thus not required in all embodiments of the present invention.

Referring to FIGS. 5A and 5B, there is shown a signal flow diagram for an example process according to aspects of the present invention. The process is similar to the example shown in FIGS. 1, 2, 3 and 4 and uses like reference numerals to indicate like components/process steps. The process shown in FIGS. 5A and 5B differs from that in FIGS. 1, 2, 3 and 4 in that the user electronic device 101 performs the steps of processing the media using a visual search 211b and executing the payment process 219 rather than the management server 103. The management server 103 is thus not required in all embodiments of the present invention.

Referring to FIG. 6, there is shown a signal flow diagram for an example process of providing media to the user electronic device 101 according to aspects of the present invention. In this example, the management server 103 adds the metadata to the media as shown in step 301. The management server 103 then transmits the media with the metadata to the content distributor server 109 in step 303. The content distributor server 109 then transmits the media with the metadata to the user electronic device in step 305. The user electronic device 101 is then able to receive a user interaction with the media as shown in step 307 and transmit the metadata back to the management server 103 as shown in step 309 in response to the user interaction.

In the above example, metadata may be added to media through cooperation between the management server 103 and the content distributor. For example, the management server 103 may provide a management tool/widget that enables the content distributor to add metadata to media items. The metadata may link the media items to the merchant and product. The content distributor is then able to distribute the media item over content networks (e.g. social media networks). The management tool/widget thus links products to participating merchants. In this way, the system is able to know what payment process the merchant uses, and is able to use this information to interface with the preferred digital wallet set up in the fulfilment application.

Referring to FIG. 7, there is shown a signal flow diagram for another example process of providing media to the user electronic device 101 according to aspects of the present invention. In this example, the content distributor server 109 distributes media to the user electronic device 101 in step 401. The media is not required to comprise metadata identifying the product or merchant. The user electronic device 101 receives a user interaction in relation to the media (step 403) and transmits the media to the management server 103 (step 405). The management server 103 than performs a searching operation to identify one or more products that match the media (step 409). For example, the media may include a visual representation of a product, and the searching item will identify one or more products for sale by one or more merchants and that match the product in the media. The management server 103 then adds metadata to media corresponding to the identified product or products. That is a plurality of media each comprising a visual representation of a different one of the identified products may be provided, and each may comprise metadata identifying the product and the merchant providing the product. The management server 103 then transmits the media with the metadata to the user electronic device 101 (step 411). The user electronic device 101 is then able to receive a user interaction with the media as shown in step 413 and transmit the metadata back to the management server 103 as shown in step 415 in response to the user interaction.

In summary, there is provided a method and system for fulfilling an action with a fulfilment entity via a fulfilment server. The method comprises, in response to receiving a user input in relation to a media item, using the media item to obtain information identifying the fulfilment entity 211. The method comprises interacting with the fulfilment entity using the obtained information identifying the fulfilment entity to fulfil the action 219. The media item is from a content distributor entity. The content distributor entity is different to the fulfilment entity.

In other words, there is provided a control system and method for assigning metadata to media so that products can be linked with consumer's details and preferred payment methods, to enable frictionless e-commerce.

The content distributor entity may use a management widget or tool to add metadata to media items. The metadata may link the media item to a merchant and product. The content distributor entity may then upload the media item to a content channel, such as social media. The management widget or tool may check if the fulfilment application is installed on the user application device, and may show an icon over the displayed media item to enable a user to purchase a product shown in the media item. The products linked by the widget/tool to participating merchants enable the system to know what payment server should be used for the corresponding merchant. The system may interface with a digital wallet on the user electronic device to perform the purchase.

The details of the media item with the metadata, a record of where and when the media item appears on the user electronic device, and a record of the media item used for payment may be stored on a database.

The user of the electronic device may tap on the icon, and the fulfilment application may connect to a preferred payment server passed on the users pre-stored payment options. The user electronic device may then interface with the preferred payment server to purchase the product, e.g. by sending money to the merchant to purchase the product, and by providing details required for fulfilment of the purchase. Such details may include the size, colour, style, address, email address, and phone number amongst others. The payment server may send through confirmation of the payment and customer details to the merchant via the merchant server.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Although a few preferred embodiments of the present invention have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A computer-implemented method of fulfilling an action with a fulfilment entity via a fulfilment server, the method comprising:
in response to a user input in relation to a media item, using the media item to obtain information identifying the fulfilment entity; and
interacting with the fulfilment entity using the obtained information identifying the fulfilment entity to fulfil the action, wherein the media item is from a content distributor entity, the content distributor entity being different to the fulfilment entity.

2. The method of claim 1, wherein interacting with the fulfilment entity to fulfil the action comprises controlling the fulfilment server to fulfil the action.

3. The method of claim 1, further comprising using the media item to obtain information identifying the action, and wherein interacting with the fulfilment entity comprises using the information identifying the action and the information identifying the fulfilment entity to fulfil the action.

4. The method of claim 3, wherein using the media item comprises processing metadata associated with the media item to obtain the information identifying the action.

5. The method of claim 1, wherein using the media item comprises processing metadata associated with the media item to obtain the information identifying the fulfilment entity.

6. The method of claim 4, wherein the metadata comprises an identifier for the action and/or the fulfilment entity.

7. The method of claim 6, wherein using the media item comprises using the identifier to look up the information identifying the action and/or the information identifying the fulfilment entity from a data store.

8. The method of claim 1, wherein using the media item comprises performing a visual search operation using the media item so as to identify the fulfilment entity.

9. The method of claim 1, wherein the method comprises receiving the media item from a content distributor server.

10. The method of claim 1, wherein the method comprises displaying the media item on a display of a user electronic device.

11. The method of claim 1, wherein the method comprises inserting metadata into a media item, the metadata being for use in obtaining the information identifying the fulfilment entity.

12. The method of claim 11, wherein inserting metadata into a media item comprises: receiving a media item in response to a user input in relation to the media item; identifying the fulfilment entity associated with the media item; and inserting metadata comprising information for use in identifying the fulfilment entity into the media item.

13. The method of claim 11, wherein the method comprises transmitting the media item comprising the metadata to the content distributor entity.

14. The method of claim 1, wherein the action comprises undertaking a financial transaction to purchase a product or service associated with the media item, wherein the fulfilment entity is a merchant entity, and wherein interacting with the fulfilment entity comprises performing a payment process for purchasing the product or service from the merchant entity via the merchant server using the obtained information identifying the fulfilment entity.

15. A computerised system for fulfilling an action with a fulfilment entity via a fulfilment server, the system being arranged to perform the method as claimed in claim 1.
